(19) United States
(12) Patent Application Publication
(10) Pub. No.: US 2024/0317643 A1
(43) Pub. Date: Sep. 26, 2024

(54) CEMENT BASED TILE ADHESIVE DRY MIX COMPOSITIONS CONTAINING CROSSLINKED CELLULOSE ETHERS FOR MORTARS WITH ENHANCED GEL STRENGTH

(71) Applicant: Dow Global Technologies LLC, Midland, MI (US)

(72) Inventors: Alexandra Hild, Soltau (DE); Jörn Breckwoldt, Hamburg (DE)

(21) Appl. No.: 18/546,987

(22) PCT Filed: May 2, 2022
(86) PCT No.: PCT/US2022/027273

§ 371 Date: Aug. 18, 2023

Related U.S. Application Data
(60) Provisional application No. 63/183,111, filed on May 3, 2021.

(51) Int. Cl. C04B 14/06; C04B 7/02; C04B 24/38; C04B 28/04; C04B 111/00

(52) U.S. Cl. CPC C04B 14/06; C04B 7/02; C04B 24/386; C04B 28/04; C04B 2111/00646

(57) ABSTRACT

The present invention provides dry mix compositions for cement-based tile adhesives having both improved open time and slip resistance comprising one or more gel-like crosslinked cellulose ethers containing polyether groups, preferably, a mixed cellulose ether having polyoxypropylene dioxyethylene ether crosslinks. The gel-like water-soluble crosslinked cellulose ethers containing polyether groups of the present invention are formed from low to medium viscosity cellulose ethers and contain polyether groups having from 2 to 15, or, preferably, 13 or fewer oxyalkylene groups, or, preferably, 7 or more oxyalkylene groups. The present invention also provides methods of using the dry mixes in cement-based tile adhesives.

### FIELD OF THE INVENTION

The present invention relates to dry mix compositions comprising cement and at least one gel-like crosslinked cellulose ether containing polyether groups and having improved open time and slip resistance for use in making cement-based tile adhesives, as well as methods for using the compositions.

### BACKGROUND OF THE INVENTION

Cellulose ethers are employed in mortars in various construction applications impart water retention properties that limit loss of water from the mortar to absorbing substrates as well as to improve the rheology of the mortar. For example, cellulose ethers have found use in cement-based tile adhesives, by applying the wet adhesive to the back of a tile and adhering it to a substrate. Additionally, cellulose ethers allow for a steady setting rate and high final mechanical strength. Such cellulose ethers (CE) may be crosslinked with permanent crosslinking agents such as epichlorohydrine (ECH) during etherification. These crosslinked cellulose ethers can be rheologically characterized by having a storage modulus to loss modulus G′/G″ intersection at very low angular frequencies and can be stated to have “low cross-over values (COV)”. Such G′/G″ intersections at low angular frequencies can be associated with the formation of three-dimensional branched networks (i.e. gels); therefore, crosslinked cellulose ethers are described as “gel-like” cellulose ethers or cellulose ethers with improved gel-strength.

Cement-based tile adhesives comprise dry mix compositions for mortars that are formulated with cellulose ethers, cement and fillers. The dry mortars are mixed with water, allowed to sit for, for example, up to 10 minutes to build a proper consistency and are then thinly applied to a substrate against which the tile will be laid. In standard quality and high-quality tile adhesives, characterized, respectively, as C1 and C2 in accordance with a EN 12004 standard, key end-use properties influenced by the cellulose ethers are the workability of the fresh mortar, the slip resistance and mechanical strength requirements according to the appropriate EN standard. However, the addition rate or dosage of conventional cellulose ethers to create sufficient water retention to retain a useful workability and open time remains high, for example, from more than 0.3 to 0.6 wt. %, based on total solids. In use, if the cement-based tile adhesive mortar fails to retain good open time and initial wet mortar properties, it has to be discarded and a new mortar batch must be made. However, there remains a need for a dry mix composition having both wet mortar and mechanical or cured product properties; thus, if cellulose ethers have thus far enabled improved open time in cement-based tile adhesives, they have not enabled improved slip resistance of the tile in use. Accordingly, there remains a need to provide cellulose ethers that in cement-based tile adhesives allow one to maintain or improve both open time and tile slip resistance in use, especially for heavy tiles.

U.S. Pat. No. 10,150,704 B2, to Hild et al. discloses cement-based tile adhesives comprising gel-like crosslinked cellulose ethers. The adhesives demonstrate improved adhesion strength and at the same time dosage reduction of 20% or more in comparison to other cellulose ethers. However, Hild et al. demonstrate adhesion strength, which is measured in hardened dry mortars. Hild et al. fail to disclose dry mix compositions that enable improved wet mortar properties, particularly open time.

The present invention seeks to solve the problem of providing cementitious cement-based tile adhesive compositions comprising cellulose ethers that form wet mortars or adhesives having both improved open time and slip resistance.

### STATEMENT OF THE INVENTION

In accordance with the present invention, a dry mix composition for making cement-based tile adhesives comprises:

from 20 to 40 wt. %, or, preferably, from 30 to 38 wt. % of a cement, such as ordinary Portland cement or a high clinker Portland cement having from 47 to 55 wt. %, as solids, of an alkali or alkaline metal containing clinker;

from 59.25 to 79.88 wt. %, or, preferably, from 61.4 to 68.85 wt. % of sand or an inorganic filler, such as, for example, crushed calcium carbonate having a sieve particle size of from 80 μm to 0.8 mm, or, preferably, from 0.1 to 0.5 mm, or a mixture thereof; and,

from 0.12 to 0.75 wt. %, or, preferably, from 0.15 to 0.6 wt. %, or, more preferably, from 0.2 to 0.45 wt. % of one or more gel-like crosslinked cellulose ethers containing polyether groups, preferably, a mixed cellulose ether that contains hydroxyalkyl groups and alkyl ether groups, all weight proportions based on total weight solids in the dry mix composition and all weight proportions in the dry mix compositions adding up to 100%.

The dry mix composition may further comprise from 0.5 to 5 wt. %, or, from, 1 to 3.5 wt. %, or, preferably, from 1 to 2.5 wt. % of one or more water redispersible polymer powders (RDP), such as any RDP containing ethylene-vinyl acetate (co)polymers, acrylate copolymers, or styrene acrylate copolymers.

In accordance with another aspect of the present invention, a method of using the dry mix composition comprises:

mixing the dry composition mix with water to form a cement-based tile adhesive;

applying the tile adhesive to a substrate, such as a porous substrate, to form an adhesive bearing substrate; and,

applying a tile or, preferably, a heavy tile having a top or bottom surface area of at least 200 cm², or, more preferably, at least 220 cm², to the adhesive bearing substrate. The substrate may comprise, for example, concrete, gypsum board, backer board, plywood, wood, a fiber cement board, a cement render, cured mortar, or another unfinished substrate.

In accordance with the dry mix compositions or the method of using the dry mix compositions of the present invention, a 1.0 wt. % aqueous solution or dispersion of the one or more gel-like crosslinked cellulose ether containing polyether groups has a crossover point (COV) at which storage modulus (G′) and loss modulus (G″) intersect and are identical when measured by oscillation rheometry, of from greater than 1.5 to 8 radians per second (ω in rad/s), or, for example, from 2 to 7 rad/s,

wherein the aqueous solution or dispersion is lump and gel free and is formed by dispersing 1.0 wt. % of the cellulose ether, on a dry basis, under high shear in 99.0 wt. % of water using a high speed laboratory stirrer at 2500 rpm by slowly adding dry cellulose ether to the water in a glass container with continuous stirring over a period of 10 sec and continuing stirring at 2500 rpm for an additional 10 sec, followed by sealing the container and rotating the container slowly about its longitudinal (horizontal) axis for a period of 1.5 h, and,

further, the G′ and G″ being measured in Pascal at 20° C. using an oscillating rheometer (Anton Paar MCR 302, Anton Paar, Graz, AT) rheometer equipped with a plate having a 50 mm diameter and a cone having a 1° cone angle and a 0.05 mm flattening of the cone point, and varying the angular frequency (ω) in a range of from 0.1 to 100 ω with a deformation of 0.5%. Preferably, a ratio of the COV of the gel-like crosslinked cellulose ether to the COV of the same cellulose ether absent crosslinking ranges from 1:15 to 0.5:1 or, preferably, from 0.1:1 to 0.4:1.

Preferably, in the compositions of making the dry mix compositions or in the methods of using the dry mix compositions in accordance with the present invention, the dry mix composition comprises at least one gel-like crosslinked cellulose ether having a polyether group which is a polyoxyalkylene and has from 2 to 15 or, preferably, 3 to 13, or, 7 or more, or, more preferably, from 4 to 12 oxyalkylene groups. More preferably, the polyether group in at least one of the gel-like crosslinked cellulose ethers is a polyoxypropylene.

Preferably, in the dry mix compositions or in the methods of using the dry mix compositions in accordance with the present invention, at least one of the one or more gel-like crosslinked cellulose ethers is a mixed cellulose ether that contains hydroxyalkyl groups and alkyl ether groups and has a degree of hydroxyalkyl substitution MS (HE) of from 0.05 to 0.8, or, more preferably, from 0.10 to 0.45, and, further, has a degree of alkyl substitution DS (M) of from 1.2 to 2.1 or, more preferably, from 1.3 to 1.7.

Preferably, in the dry mix compositions or in the methods of using the dry mix compositions in accordance with the present invention, at least one of the one or more gel-like crosslinked cellulose ethers is a mixed cellulose ether that contains hydroxyalkyl groups and alkyl ether groups and that has polyoxypropylene dioxyethylene ether crosslinks. Even more preferably, at least one of the one or more gel-like crosslinked cellulose ether is a hydroxyethyl methyl cellulose containing polyoxypropylene dioxyethylene ether crosslinks, such as the reaction product of hydroxyethyl methyl cellulose with polypropylene glycol (PPG) glycidylether.

In the dry mix compositions or in the methods of using the dry mix compositions in accordance with the present invention, at least one of the one or more gel-like crosslinked cellulose ethers comprises a crosslinked cellulose ether at least partly from wood pulp in the amount of, for example, at least 20 wt. %, or from 20% to 100%, or, from 20% to 80%, based on the total solids weight of the cellulose ether.

Preferably, in the dry mix composition in accordance with the present invention or in the methods of using the dry mix composition in accordance with the present invention, a dry mix composition comprises at least one gel-like crosslinked cellulose ether containing polyether groups,

wherein a test cement-based tile adhesive comprising the gel-like crosslinked cellulose ether would exhibit each of a 30 minute open time as determined in accordance with EN 1348 of at least 1.0 N/mm², or, preferably, at least 1.2 N/mm² after each of (i) 28 day aging at 23° C.±2° C. and standard (101.3 kPa) pressure, (ii) 7 days plus 7 hours aging at 23° C.±2° C. and standard (101.3 kPa) pressure and 20 days plus 17 hours water immersion at 23° C.±2° C. and standard (101.3 kPa) pressure, and (iii) 14 day aging at 23° C.±2° C. and standard (101.3 kPa) pressure and then 70° C. heat aging for 14 days when tested in a test dry mix composition at a 0.4 wt. % solids loading of the gel-like crosslinked cellulose ether containing polyether groups in the test cement-based tile adhesive formed by mixing a test dry mix composition comprising 0.4 wt. %, as solids, of the gel-like crosslinked cellulose ether containing polyether groups and further comprising 35 wt. %, as solids, of ordinary Portland cement, 0.05 wt. %, as solids, of a slip resistance aid, and the remainder of sand and/or a filler, all weight proportions based on the total weight of the test dry mix composition solids and adding up to 100%, with water in accordance with EN 12004:2 (2017) to provide a test cement-based tile adhesive having a viscosity of 400 to 700 Pa·s at 25° C., as measured using a Brookfield rheometer RVDV II Pro (DV II+) equipped with a Helipath stand and spindle No. T96 at 5 rpm.

Preferably, in the dry mix composition in accordance with the present invention or in the methods of using the dry mix composition in accordance with the present invention, the dry mix composition comprises at least one gel-like crosslinked cellulose ether containing polyether groups,

wherein a test cement-based tile adhesive comprising the gel-like crosslinked cellulose ether would exhibit a slip resistance of 1.7 mm or less, or, preferably, 1.5 mm or less, as determined in accordance with EN 1308 on a cement substrate when tested at a 0.4 wt. % solids loading of the gel-like crosslinked cellulose ether in the test cement-based tile adhesive formed by mixing a test dry mix composition comprising 0.4 wt. %, as solids, of the gel-like crosslinked cellulose ether containing polyether groups, and further comprising 35 wt. %, as solids, of ordinary Portland cement, no slip aid and the remainder of sand and/or a filler, all weight proportions based on the total weight of the test dry mix composition solids and adding up to 100%, with water in accordance with EN 12004:2 (2017) to provide a test cement-based tile adhesive having a viscosity of 450 to 700 Pa·s at 25° C., as measured using a Brookfield rheometer RVDV II Pro (DV II+) equipped with a Helipath stand and spindle No. T96 at 5 rpm.

Unless otherwise indicated, all temperature, pressure and humidity units are room temperature (20 to 24° C. or “room temperature” (RT)), standard pressure (1 atm) and a relative humidity (RH) of 50%.

Unless the context clearly dictates otherwise, the singular forms “a,” “an,” and “the” include plural referents.

Unless defined otherwise, technical and scientific terms used herein have the same meaning as is commonly understood by one skilled in the art.

All phrases comprising parentheses denote either or both of the included parenthetical matter and its absence. For example, the phrase “(poly)oxyalkylene” includes, in the alternative, polyoxyalkylene and oxyalkylene.

All ranges recited are inclusive and combinable. For example, a disclosure of from 0.12 to 0.75 wt. %, or, preferably, from 0.15 to 0.6 wt. %, or, more preferably, from 0.2 to 0.45 wt. % will include all of from 0.12 to 0.75 wt. %, or, preferably, from 0.15 to 0.6 wt. %, or, from 0.12 to 0.15 wt. %, or, from 0.12 to 0.2 wt. %, or, from 0.12 to 0.45 wt. %, or, from 0.12 to 0.6 wt. %, or, from 0.15 to 0.75 wt. % or, preferably, from 0.15 to 0.2 wt. %, or, more preferably, from 0.15 to 0.45 wt. %, or, more preferably, from 0.2 to 0.45 wt. %, or, preferably, from 0.2 to 0.6 wt. %, or, from 0.2 to 0.75 wt. %, or, preferably, from 0.45 to 0.6 wt. %, or, from 0.45 to 0.75 wt. %, or, from 0.6 to 0.75 wt. %.

As used herein, the term “anhydroglucose unit” or “AGU” refers to a monosaccharide in (co)polymerized form or as part of a polysaccharide.

As used herein the term “aqueous” means that the continuous phase or medium is water and from 0 to 10 wt. %, based on the weight of the medium, of water-miscible compound(s). Preferably, “aqueous” means water.

As used herein, the phrase “based on total solids” refers to weight amounts or weight proportions of all of the non-volatile ingredients in a given composition, including synthetic polymers, cellulose ethers, acids, defoamers, hydraulic cement, sand, fillers, other inorganic materials, and other non-volatile additives. Water, ammonia and volatile solvents are not considered solids.

As used herein, the term “crossover point” means the angular frequency (ω) in radians/s as determined by oscillation rheometry, at which the storage modulus (G′) and loss modulus (G″) intersect and are identical, wherein G′ and G″ are measured in Pascal by oscillation rheometry as a function of angular frequency (ω) at 20° C. using e.g. an Anton Paar MCR 302 oscillating rheometer (Anton Paar, Graz, AT) equipped with a plate having a 50 mm diameter and a cone having a 1° cone angle and a 0.05 mm flattening of the cone point, varying angular frequency (ω) in a range of (ω) from 0.1 to 100 with a deformation of 0.5%. In the rheometry, the analyte cellulose ether or crosslinked cellulose ether is dissolved in water by dispersing 1.0 wt. % of the cellulose ether under shear, on a dry basis, in 99.0 wt. % of water using a high speed laboratory stirrer at 2500 rpm by slowly adding dry cellulose ether to the water in a glass container with continuous stirring over a period of 10 sec and continuing stirring at 2500 rpm for an additional 10 sec, followed by sealing the container and rotating the container slowly about its longitudinal (horizontal) axis for a period of 1.5 h.

As used herein the term “DIN EN” or “EN” refers to a European Norm version of a German materials specification, published by Beuth Verlag GmbH, Berlin, DE. And, as used herein, the term “DIN” refers to the German language version of the same materials specification.

As used herein the term “dry mix” means a storage stable powder containing cement, cellulose ether, any other polymeric additive, and any fillers or sand and dry additives. No water is present in a dry mix; hence it is storage stable.

As used herein the term “DS” is the mean number of alkyl substituted OH-groups per anhydroglucose unit in a cellulose ether . . . the term “MS” is the mean number of hydroxyalkyl substituted OH-groups per anhydroglucose unit, as determined by the Zeisel method. The term “Zeisel method” refers to the Zeisel Cleavage procedure for determination of MS and DS, see G. Bartelmus and R. Ketterer, Fresenius Zeitschrift fuer Analytische Chemie, Vol. 286 (1977, Springer, Berlin, DE), pages 161 to 190.

As used herein the term “low or medium viscosity crosslinked cellulose ether” means a crosslinked cellulose ether which, absent crosslinking, would have a viscosity of from 10,000 to 40,000 mPas measured as a 2 wt. % solution in water using a Haake Rotovisko™ RV 100 rheometer (Thermo Fisher Scientific, Karlsruhe, DE) at 20° C. and a shear rate 2.55 s⁻¹.

As used herein the term “high viscosity crosslinked cellulose ether” means a crosslinked cellulose ether which, absent crosslinking, would have a viscosity of more than 40,000 mPas measured as a 2 wt. % solution in water using a Haake Rotovisko™ RV 100 rheometer (Thermo Fisher Scientific, Karlsruhe, DE) at 20° C. and a shear rate 2.55 s⁻¹.

As used herein, the term “ISO” refers to publications of the International Organization for Standardization, Geneva CH.

As used herein, the term “mean diameter” means the value (×50) or arithmetic mean as determined by light scattering.

As used herein, the term “mortar viscosity” or “tile adhesive viscosity” refers to a viscosity in Pa·s at room temperature of a composition mixed in accordance with EN 12004:2 (2017) at 25° C., as measured in a cup (h=80 mm, d=100 mm) using a Brookfield viscometer RVDV II Pro (DV-II+) equipped with a Helipath stand and spindle no T-F 96 used at 5 rpm, and calibrated as per the manufacturer's instructions. Acceptable room temperature tile adhesive viscosities may range from 450 to 700 Pa·s.

As used herein, unless otherwise indicated, the term “open time” or “open time adhesion” refers to the result as determined in accordance with EN 1346 and shows the length of time within which the wet or back side of a given tile can still be sufficiently wetted and adhered when laying the tile into a combed bed of a given tile adhesive on a base. In the test, each tile is laid into a bed of a given tile adhesive at any one time interval, i.e. after any of 5, 10, 15, 20, 25 and 30 minutes to form the tile adhesive bed, and then each tile is weighed down with a 3 kg weight for 30 s, then the thus adhered tiles are aged, such as in 28 day standard conditions (RT and 1 atm), and then subject to tensile adhesion testing in accordance with EN 1348 by gluing a tensile test plate to the top of the tile and pulling the tile off the base using a tensile tester. The force required to remove the tile from the base is reported in N/mm² as the open time, citing the aging conditions and the time interval tested.

As used herein the term “set” refers to the curing of a tile adhesive which happens under ambient conditions in the presence of water and continues as the tile adhesive dries.

As used herein the term “sieve particle size” or “sieve average particle size” of a material refers to a particle size as determined by sieving the material through successively smaller size mesh sieves until at least 10 wt. % of the material is retained on a given sieve and recording the size of the sieve that is one sieve size larger than the first sieve which retains at least 10 wt. % of the material. Sieve particle size can also be determined using a LAVIB sieve machine (Siebtechnik, Muelheim, DE) and reported as a limit, for example, wherein 100% of the particle size is less than the measured and reported size.

As used herein the term “wt. % of total solids” means the weight of all non-volatile ingredients of a given composition, as determined by volatility at temperatures of 40° C. or below and atmospheric pressure. Volatiles include water, solvents that evaporate under conditions of ambient temperature and pressure, like methyl chloride.

As used herein, the term “wt. %” refers to percent by weight.

### DETAILED DESCRIPTION OF THE INVENTION

In accordance with the present invention, gel-like crosslinked cellulose ethers containing polyether groups enable the provision of dry mix compositions and mortars for use in making cement-based tile adhesives that have the same or improved slip resistance and open time. The gel-like cellulose ethers are irreversibly crosslinked and exhibit a gel-like behavior marked by an increase in storage modulus at a low angular frequency in response to oscillation rheometry. The gel-like crosslinked cellulose ethers in accordance with the present invention contain less than 15, or preferably, less than 13 polyether groups and more than 3 polyether groups, or, preferably, more than 6 polyether groups, or, more preferably, more than 7 polyether groups. The gel-like behavior translates into improved open time in use as, for example, a tile adhesive while maintaining a good slip resistance even at a gel-like crosslinked cellulose ether loading 0.4 wt. % solids or less. Further, it has been found that the use of crosslinked cellulose ethers containing polyether groups in the crosslinker, preferably mixed cellulose ethers containing alkyl ether and hydroxyalkyl groups, significantly improve the slip resistance behavior of cement-based tile adhesives without the use of slip aids.

In the gel-like crosslinked cellulose ethers of the present invention, alkyl substitution is described in cellulose ether chemistry by the term “DS”. The DS is the mean number of substituted OH groups per anhydroglucose unit. The methyl substitution may be reported, for example, as DS (methyl) or DS (M). The hydroxy alkyl substitution is described by the term “MS”. The MS is the mean number of moles of etherification reagent which are bound as ether per mol of anhydroglucose unit. Etherification with the etherification reagent ethylene oxide is reported, for example, as MS (hydroxyethyl) or MS (HE). Etherification with the etherification reagent propylene oxide is correspondingly reported as MS (hydroxypropyl) or MS (HP). The side groups are determined using the Zeisel method (reference: G. Bartelmus and R. Ketterer, Fresenius Zeitschrift fuer Analytische Chemie 286 (1977), 161-190).

A suitable crosslinked hydroxyalkyl group containing cellulose ether has a degree of hydroxyalkyl substitution MS (HE) of from 1.1 to 2.5, or, preferably, a degree of substitution MS (HE) of from 1.2 to 2.0.

Preferably, mixed ethers of methyl cellulose, such as hydroxyethyl cellulose (HEMC) or hydroxypropyl methyl cellulose (HPMC) are crosslinked. In the case of HEMC, a preferred methyl substitution DS (M) values ranges from 1.2 to 2.1 or, more preferably, from 1.3 to 1.7, or, even more preferably, from 1.35 to 1.65, and hydroxyalkyl substitution MS (HE) values range from 0.05 to 0.8, or, more preferably, from 0.10 to 0.45, or, even more preferably, 0.15 to 0.40. In the case of HPMC, preferably, DS (M) values range from 1.2 to 2.1, or, more preferably, from 1.3 to 2.0 and MS (HP) values range from 0.1 to 1.5, or, more preferably, from 0.15 to 1.2.

Methods for crosslinking cellulose ethers to make the polyether group containing cellulose ethers of the present invention may comprise crosslinking the cellulose ethers in a reactor in which the cellulose ether itself is made and in the presence of caustic or alkali. For example, the gel-like crosslinked cellulose ethers containing polyether groups are made using methods known in the art by reacting cellulose with etherifiying reagents and a crosslinking agent, for example, as disclosed in U.S. Pat. No. 10,150,704 B2, to Hild et al., or by reacting a cellulose ether with a crosslinking agent. Thus, the crosslinking reaction is thus generally conducted in the process of making a cellulose ether from cellulose. Because the process of making a cellulose ether comprises stepwise addition of reactants to form alkyl or hydroxyalkyl groups on cellulose, preferably, the crosslinking of the cellulose ethers is preceded by (i) one or more addition of alkyl halide, e.g. methyl chloride, in the presence of alkali to form alkyl ethers of the cellulose or (ii) alkylene oxide in the presence of alkali to form hydroxyalkyl groups on the cellulose; or (iii) both (i) and (ii).

Any step in the stepwise addition to form alkyl, hydroxyalkyl or ether groups on cellulose, whether it occurs before, during or after the crosslinking of the cellulose ethers may independently take place at a temperature of from 40 to 90° C., preferably, wherein a second or subsequent step may occur at a higher temperature, for example, 65° C. or higher, and/or pressure than a first (hydroxy)alkylation, etherification or crosslinking.

So that the cellulose ethers are not degraded or broken down in processing, the crosslinking reaction is carried out in an inert atmosphere, such as under nitrogen, and at temperatures of from room temperature to 90° C. or less, or, preferably, at as low a temperature as is practicable; for example, the process preferably is carried out at from 60° C. to 90° C. or, preferably, 70° C. or more.

Suitable cellulose ethers for use in making the crosslinked polyether group containing cellulose ethers of the present invention may include, for example, a hydroxyalkyl cellulose or an alkyl cellulose, or a mixture of such cellulose ethers. Examples of cellulose ether compounds suitable for use in the present invention include, for example, methylcellulose (MC), ethyl cellulose, propyl cellulose, butyl cellulose, hydroxyethyl methylcellulose (HEMC), hydroxypropyl methylcellulose (HPMC), hydroxyethyl cellulose (“HEC”), ethylhydroxyethylcellulose (EHEC), methylethylhydroxyethylcellulose (MEHEC), hydrophobically modified ethylhydroxyethylcelluloses (hmEHEC), hydrophobically modified hydroxyethylcelluloses (hmHEC), sulfoethyl methylhydroxyethylcelluloses (SEMHEC), sulfoethyl methylhydroxypropylcelluloses (SEMHPC), and sulfoethyl hydroxyethylcelluloses (SEHEC). Preferably, the cellulose ethers are mixed cellulose ethers that contain hydroxyalkyl groups and alkyl ether groups, such as alkyl hydroxyethyl celluloses, such as hydroxyalkyl methylcelluloses, for example, hydroxyethyl methylcellulose (HEMC), hydroxypropyl methylcellulose (HPMC), methyl hydroxyethyl hydroxypropylcellulose (MHEHPC), methyl hydroxyethylcellulose (MEHEC), and ethylhydroxyethyl cellulose (EHEC).

Crosslinking agents suitable for use in the present invention may include compounds having a polyoxyalkylene or polyalkylene glycol group and two or more, preferably, two crosslinking groups, such as glycidyl or epoxy groups that form ether bonds with the cellulose ether in crosslinking the cellulose ether. Suitable bifunctional compounds may be chosen from, for example, diglycidyl polyalkoxy ethers, diglycidyl phosphonate, divinyl polyoxyalkylenes containing a sulphone group. Examples of these are diglycidyl polyoxypropylenes and glycidyl(poly)oxyalkyl methacrylates, preferably, diglycidyl polyalkoxy ethers, e.g. diglycidyl polyoxypropylene; glycidyl(poly)oxyalkyl methacrylate; diglycidyl phosphonates; or divinyl polyoxyalkylenes containing a sulphone group. The crosslinking agents contain 15 or fewer, or, preferably, 13 or fewer, or, 7 or more, or, more preferably, an average of 12 or fewer or 7 or more ether or alkoxy groups. Preferably, the crosslinking agents comprise repeat units of propoxy groups or ethoxy groups and have a molecular weight of 1000 or less, or, preferably, 900 or less, or, more preferably, 880 or less, wherein the molecular weight is calculated as two times of the Epoxy Equivalent Weight in accordance with to DIN EN 16945. Preferably, the crosslinker has a molecular weight of greater than 410, as calculated in accordance with DIN EN 16945.

The amount of crosslinking agent used to make the gel-like crosslinked cellulose ether containing polyether groups in accordance with the present invention may range from 0.0001 to 0.05 eq, where the unit “eq” represents the molar ratio of moles of the respective crosslinking agent relative to the number of moles of anhydroglucose units (AGU) in the cellulose ether. The preferred amount of crosslinking agent used is 0.0005 to 0.01 eq, or, more preferably, the amount of crosslinking agent used is 0.001 to 0.005 eq. As used herein, the unit “eq” represents the molar ratio of moles of the respective crosslinking agent relative to the number of moles of anhydroglucose units (AGU) in the cellulose ether.

After the polyether group containing cellulose ethers of the present invention are made, they are granulated and dried. Granulation may follow dewatering or filtering to remove excess water, if needed.

The dry mix compositions in accordance with the present invention further comprise a finely divided cement, such as a hydraulic cement powder, like ordinary Portland cement, or, preferably a high clinker Portland cement having from 47 to 55 wt. %, as solids, of an alkali(ne) metal oxide or silicate. The high clinker Portland cement gives a higher viscosity cement-based tile adhesive than ordinary Portland cement. Dry cements may be used in weight proportions of from 20 to 40 wt. %, or, preferably, from 30 to 38 wt. %, based on the total weight of dry mix.

The dry mix compositions in accordance with the present invention further comprise from 59.25 to 79.88 wt. %, or, preferably, from 61.4 to 68.85 wt. % of sand or a finely divided filler. Suitable fillers may be chosen from alkaline earth carbonates and silicates, such as calcium or magnesium carbonates and silicates, as well as calcined, sintered or ceramic forms thereof, such as dolomite, kaolinite, calcium carbonate, magnesium carbonate, talc, silica sand, or alkali metal silicates, sodium silicate or their mixtures.

The dry mix compositions in accordance with the present invention may further include a water redispersible polymer powder (RDP). RDPs may be formed in a conventional manner by spray drying an emulsion polymer binder formed by conventional aqueous emulsion polymerization. Aqueous emulsion polymers may be selected from various compositional classes such as, for example, vinyl acetate polymers, vinyl acetate-acrylic copolymers, vinyl acetate-ethylene copolymers, acrylic polymers, styrene-acrylic polymers, styrene-butadiene copolymers, and blends thereof. RDP compositions further include anticaking agents such as clays and colloidal stabilizers, such as poly(vinylalcohol), which enable spray drying to form affinely divided powder. RDPs may improve adhesion and durability of the skim coat mortar.

The dry mix compositions of the present invention may comprise up to 1 wt. % of any one or more additional ingredients in dry form such as accelerators, such as calcium formate, superplasticizers, additional organic or inorganic thickening agents and/or secondary water retention agents, anti-sag agents, wetting agents, defoamers, dispersants, water repellents, biopolymers, or fibres. All of the additional ingredients are known in the art and are commercially available. All additional ingredients are known in the art and are available from commercial sources.

The dry mix compositions in accordance with the present invention are formed by mixing all of the materials of the present invention in dry form. The dry mix compositions can be stored for later use. Cementitious compositions are generally used as a dry mix powder by adding water thereto and mixing to form a cement-based tile adhesive. Cementitious tile adhesives compositions can be stored, sold or used as a dry mix powder.

The compositions of the present invention find use as cement-based tile adhesives. In accordance with the present invention, the methods of using the dry mix comprise combining the dry mix with water to form a cement-based tile adhesive, such as one having a viscosity of 450 to 700 Pa·s when mixed in accordance with EN 12004:2 (2017) at 25° C. to form a cement-based tile adhesive, applying the cement-based tile adhesive on substrates, such as porous substrates, for example, plywood, wood, sheathing, backer board, gypsum board, Hardie board, concrete or cement renders, to form an adhesive bed, and then laying or applying a tile onto the adhesive bed.

The present invention provides for the following features:
1. In accordance with the present invention dry mix compositions for use in making cement-based tile adhesive mortars comprise from 20 to 40 wt. % or, preferably, from 30 to 38 wt. % of a cement, such as ordinary Portland cement or a high clinker Portland cement having from 47 to 55 wt. %, as solids, of an alkali or alkaline metal containing clinker;

from 59.25 to 79.88 wt. %, or, preferably, from 61.4 to 68.85 wt. % of one or more of sand, fillers chosen from dolomite, kaolinite, calcium carbonate, for example, crushed calcium carbonate, talc, silica sand, white silica sand, alkali metal silicates, or mixtures thereof, the sand or filler having a sieve average particle size of 100% from 80 μm to <0.8 mm, or, preferably, 100% from 80 μm to <0.5 mm, or mixtures thereof; and,

from 0.12 to 0.75 wt. %, or, preferably, from 0.15 to 0.6 wt. %, or, more preferably, from 0.2 to 0.45 wt. %, of one or more gel-like crosslinked cellulose ethers containing polyether groups, preferably, a mixed cellulose ether that contains hydroxyalkyl groups and alkyl ether groups, or, more preferably, a mixed cellulose ether that contains propoxy groups as ether groups, or, even more preferably, a mixed cellulose ether that contains from 2 to 15 ethoxy or propoxy groups as ether groups, or, even still more preferably, a mixed cellulose ether that contains from 3 to 13 ethoxy or propoxy groups as ether groups, or, yet even more still preferably, from 7 to 13 ethoxy or propoxy groups as ether groups, all weight proportions being wt. % of total solids in the dry mix composition and all weight proportions in the dry mix compositions adding up to 100%.
2. In accordance with the dry mix compositions of item 1, above, wherein at least one of the one or more gel-like crosslinked cellulose ethers is the crosslinked reaction product of a crosslinked cellulose ether which, absent crosslinking, would have a viscosity of from 5,000 to 36,000 mPa·s, or, preferably, from 5,000 to 32,000 mPa·S, or, for example, 5,000 to 25,000 mPa·s when measured as a 2 wt. % solution in water using a rotational rheometer (Haake Viscotester™ VT550 by Thermo Fisher Scientific, USA) at 20° C. and a shear rate 2.55 s⁻¹.
3. In accordance with the dry mix compositions any one of items 1 or 2, above, wherein at least one of the one or more gel-like crosslinked cellulose ethers is chosen from a non-mixed cellulose ether that contains alkyl ether groups, or a mixed cellulose ether that contains hydroxyalkyl groups and alkyl ether groups, such as those chosen from alkyl hydroxyethyl cellulose, e.g. hydroxyalkyl methylcellulose, or is, preferably, chosen from hydroxyethyl methylcellulose (HEMC), hydroxypropyl methylcellulose (HPMC), methyl hydroxyethyl hydroxypropylcellulose (MHEHPC), methyl ethyl hydroxyethyl cellulose (MEHEC) or ethylhydroxyethyl cellulose (EHEC), or, more preferably, HEMC.
4. In accordance with the dry mix compositions of any one of items 1, 2, or 3, above, wherein the polyether group in at least one of the one or more gel-like crosslinked cellulose ethers is a polyoxyalkylene which has from 2 to 15 or, preferably, 3 to 13, or, more preferably, from 4 to 12, or, even more preferably, from 7 to 12 oxyalkylene groups, such as, for example, oxypropylene groups.
5. In accordance with the dry mix compositions of any one of items 1, 2, 3, or 4, above, wherein the polyether group in at least one of the one or more gel-like crosslinked cellulose ethers is a polyoxyalkylene chosen a polyoxyethylene, a polyoxypropylene and combinations thereof, preferably, a polyoxypropylene.
6. In accordance with the dry mix compositions of any one of items 1, 2, 3, 4, or 5, above, wherein the gel-like crosslinked cellulose ether is a polyoxypropylene group containing hydroxyethyl methylcellulose, or, preferably, a hydroxyethyl methyl cellulose containing polyoxypropylene dioxyethylene ether crosslinks.
7. In accordance with the dry mix compositions of the present invention of any one of items 1, 2, 3, 4, 5, or 6, above, the dry mix composition further comprising from 0.5 to 5.5 wt. %, or, preferably, from, 0.5 to 3.5 wt. %, or, more preferably, from 1 to 2.5 of one or more water redispersible polymer powders (RDP), such as ethylene-vinyl acetate (VaE), copolymers of VaE with other vinyl esters, such as vinyl versatate (VeoVa), copolymers of VaE with vinyl halides, styrene acrylic copolymers, and alkyl (meth)acrylate copolymers, such as copolymers of butyl acrylate.
8. In accordance with the dry mix compositions of the present invention of any one of items 1, 2, 3, 4, 5, 6, or 7, above, wherein a 1.0 wt. % lump and gel free aqueous solution or dispersion formed by dispersing 1.0 wt. % of at least one of the one or more gel-like crosslinked ethers, on a dry basis, under high shear in 99.0 wt. % of water using a high speed laboratory stirrer at 2500 rpm by slowly adding dry cellulose ether to water in a glass container with continuous stirring over a period of 10 sec and continuing stirring at 2500 rpm for an additional 10 sec, followed by sealing the container and rotating the container slowly about its longitudinal (horizontal) axis for a period of 1.5 h, has a crossover point as measured by oscillation rheometry, at which storage modulus (G′) and loss modulus (G″) intersect and are identical, of greater than 1.5 and up to 8 rad/s, the G′ and G″ being measured in Pascal at 20° C. using an Anton Paar MCR 302 (Anton Paar, Graz, AT) rheometer equipped with a plate having a 50 mm diameter and a cone having a 1° cone angle and a 0.05 mm flattening of the cone point, and varying the angular frequency (ω) in radians/s in a range of from 0.1 to 100 rad/s with a deformation of 0.5%.
9. In accordance with the dry mix compositions of the present invention of any one of items 1, 2, 3, 4, 5, 6, 7, or 8, above, wherein a test dry mix composition comprising a 0.4 wt. % solids loading of at least one of the one or more gel-like crosslinked cellulose ethers in the dry mix composition and at least 0.005 wt. %, or, preferably, from 0.01 to 0.05 wt. %, as solids, of a slip resistance aid, such as a polyamide, a starch ether or a poly(meth)acrylamide, exhibits a 30 minute open time as determined in accordance with EN 1348 of at least 1.0 N/mm², or, preferably, at least 1.2 N/mm² after each of (i) 28 day aging at 23° C.±2° C. and standard (101.3 kPa) pressure, (ii) 7 days plus 7 hours aging at 23° C.±2° C. and standard (101.3 kPa) pressure and 20 days plus 17 hours water immersion at 23° C.±2° C. and standard (101.3 kPa) pressure, and (iii) 14 day aging at 23° C.±2° C. and standard (101.3 kPa) pressure and then 70° C. heat aging for 14 days when mixed with water in accordance with EN 12004:2 (2017) to provide a cement-based tile adhesive having a viscosity of 450 to 700 Pa·s at 25° C., as measured using a Brookfield rheometer RVDV II Pro (DV II+) equipped with a Helipath stand and spindle No. T96 at 5 rpm.
10. In accordance with the dry mix compositions of the present invention of any one of items 1, 2, 3, 4, 5, 6, 7, 8, or 9, above, comprising at least one gel-like crosslinked cellulose ether containing polyether groups,

wherein a test dry mix composition comprising a 0.4 wt. % solids loading of at least one of the one or more gel-like crosslinked cellulose ethers, and, further comprising 35 wt. % of ordinary Portland cement, no slip aid and, as the remainder, sand and/or a filler, exhibits a slip resistance of 1.7 mm or less, or, preferably, 1.5 mm or less, as determined in accordance with EN 1308 on a cement substrate, when the test dry mix composition is mixed with water in accordance with EN 1348 at RT to provide a test cement-based tile adhesive having a viscosity of 450 to 700 Pa·s at 25° C., as measured using a Brookfield rheometer RVDV II Pro (DV II+) equipped with a Helipath stand and spindle No. T96 at 5 rpm.
11. In another aspect of the present invention, the present invention provides methods of using the dry mix compositions of any one of items 1 to 10, above, comprising mixing the dry mix composition with water to form a cement-based tile adhesive, applying the adhesive to a porous substrate to form an adhesive bearing substrate, and then applying a tile to the adhesive bearing substrate.

### EXAMPLES

The following examples illustrate the present invention. Unless otherwise indicated, all parts and percentages are by weight and all temperatures are in ° C. As used in the Examples, the term “standard conditions” refers to a room temperature (23° C.±2° C.) and standard pressure (101.3 kPa). In the examples and Tables 1, 2, 3 and 4 that follow, the following abbreviations were used: RDP: Redispersible Polymer Powder; DGE: Diglycidyl ether; COV: Crossover value; VaE: vinyl acetate-ethylene; PVOH: poly(vinyl alcohol); RT: Room temperature. The following materials were used:

Cement: A high quality Portland cement CEM I 52.5 R Milke premium (Heidelberg Cement, DE) having 52.5 wt. % of an alkali or alkaline metal containing clinker or hydraulic cement reactive material;

Fine sand: Quartz sand F36 (Quarzwerke Frechen, manufacturer reported mean particle size (×50) 160 μm, specific surface area 144 cm²/g);

Medium sand: Quartz sand F32 (Quarzwerke Frechen, manufacturer reported mean particle size (×50) 240 μm, specific surface area 102 cm²/g);

Cellulose ether 1: Hydroxyethyl methyl cellulose, non-crosslinked HEMC (DS (Methyl)=1.5-1.65; MS (hydroxyethyl)=0.23-0.33; viscosity ˜29000 mPa·s, 2 wt. % aq. Solution, Haake Viscotester™ VT550, shear rate 2.55 s-1, 20° C. (Dow));

RDP1: DLP 2000 powder (DOW) Ethylene vinyl acetate/vinyl alcohol copolymer (CAS no 26221-27-2)<85.0 wt. %; Kaolin (CAS no 1332-58-7)<15.0 wt. %; partially hydrolyzed vinyl alcohol polymer (CAS no. 25213-24-5)<10.0 wt. %;

Starch Ether 1: Hydroxypropylstarch (Agrana Group, Vienna, AT, CAS no 9049-76-7);

Starch Ether 2: Hydroxypropylstarch resin more advanced than Starch Ether 1 (Agrana, CAS no 9049-76-7);

Polyacrylamide: (CAS no 7647-14-5);

Crosslinker 1: Epilox™ P13-42 poly(propyleneglycol) diglycidylether crosslinker (Leuna-Harze GmbH, Leuna, DE) is a linear poly(propyleneglycol) diglycidylether made from polypropylene glycol (PPG), and having a molecular weight of 620-680 g/mol (calculated as two times of the Epoxy Equivalent Weight in accordance with DIN EN 16945), with a viscosity (25° C. DIN 53015) of 40-70 mPa·S and having the formula below;

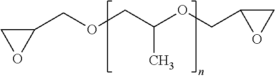

wherein n is 8.4 to 9.5.

Crosslinked cellulose ether Synthesis Example: Wood pulp cellulose flock (1.5 mol, intrinsic viscosity 1060 mL/g) was added to a 5 L autoclave. After purging the autoclave thrice with nitrogen, the reactor was heated to 40° C. Then dimethylether (DME, 4.7 mol/mol AGU), and methyl chloride (MCL, 3.2 mol/mol AGU) were injected into the autoclave. Caustic soda (NaOH) (strength 50 wt. %, 1.9 mol NaOH/mol AGU) was added in 3 portions during 2 minutes at a temperature of 40° C. The reaction mixture was held at 40° C. for 30 minutes. Ethylene oxide (0.45 mol/mol AGU) was then added and the reaction mixture was held for 10 min at 40° C. Then, the indicated amount of Crosslinker 1 dissolved in 20 ml isopropanol and added in six increments in 30 sec. intervals was added. The mass was heated to 80° C. over a period of 45 minutes. At 80° C. a second increment of MCL (1.3 mol/mol AGU) was injected quickly to the mass. Afterwards a second increment of NaOH (0.67 mol/mol AGU) was added in 7 portions over 30 minutes followed by a 70 minutes cook-off time at 80° C. Following this, the product was subject to hot water washing, neutralization with formic acid, granulation, drying and milling. Crosslinked cellulose ether 1 comprised the reaction product of 0.003 mol/AGU of crosslinker 1, while Crosslinked cellulose ether 2 comprised the reaction product of 0.0045 mol/AGU of crosslinker 1.

Cellulose ethers were tested and characterized as discussed below in the form of aqueous solutions and, as well, in cement-based tile adhesives having the indicated compositions as set forth in Tables 3, 4 and 5, below. The indicated cellulose ethers and cement-based tile adhesives were tested in the following manner:

Crossover Point or Crossover Value (COV): This gel strength test was run via oscillation rheology, as defined above, with the indicated cellulose ethers as a 1 wt. % aqueous solution or dispersion. The indicated cellulose ether or crosslinked cellulose ether was dispersed in water in the amount of 1.0 wt. % of the cellulose ether, on a dry basis, and 99.0 wt. % of water by dispersing the dry cellulose ether under high shear using a high speed laboratory stirrer (e.g. ULTRA-TURRAX™ T50, IKA™-Werke GmbH & Co. KG, Staufen, DE) at 2500 rpm by slowly adding dry cellulose ether to water in a glass container with continuous stirring over a period of 10 sec and continuing stirring at 2500 rpm for an additional 10 sec, followed by sealing the container and rotating the container slowly about its longitudinal (horizontal) axis for a period of 1.5 h.

Mixing method: Unless otherwise indicated, each cement-based tile adhesive was mixed by filling 100.0 g of the indicated dry mix composition into a plastic cup (h=80 mm, d=100 mm), loosening it briefly with a wooden stirrer, and adding the quantity of water needed to give the water to solids ratios indicated below and an acceptable viscosity of 450 to 700 Pa·s at RT (Brookfield viscometer RVDV II Pro (DV-II+) equipped with a Helipath stand and spindle no T-F 96 used at 5 rpm, and calibrated as per the manufacturer's instructions). After starting a stopwatch, the wet mixture was stirred for 30 s with the wooden stirrer and the initial thickening behavior and stirring resistance was assessed. If the adhesive could not be mixed homogeneously within the 30 s, stirring was continued to for up to 1 further minute until it was homogeneous. Then standing strength was assessed.

To assess the Standing strength of the tile adhesive, as much of the adhesive as possible was removed from the plastic cup using the wooden stirrer such that the sample lies over the narrow edge of the stirrer and is visually observed within 30 s to assess consistency. The movement and the shape of the peak of the tile adhesive (smooth, broken up, cone/peg-shaped structure) were assessed. Then the adhesive was returned to the plastic cup. After five minutes, the adhesive was stirred again for 1 min, during which its thickening behavior and stirring resistance were observed. After stirring again, the standing strength on the wooden stirrer and the surface of the adhesive were assessed for the second time. Standing strength and shear stability were visually assessed, as follows:

100%=full standing strength

97.5%=almost no movement of the tile adhesive

95%=slow continual movement

92.5%=faster continual movement

90%=faster continual movement, still good cohesion, but runs off

85%=adhesive is difficult to pick up and tears off abruptly

<80%=adhesive cannot be properly taken up onto the wooden stirrer;

adhesive has a thin/runny consistency.

An acceptable result is at least 95%; a preferred result is at least 97.5%.

Where indicated, wet cement-based tile adhesives were formed in accordance with EN 1348 by taking a 1500 g amount of the indicated dry mix composition and combining it with water in the indicated water to solids ratio using a mortar mixer TESTING type 1.0203.01 for 30 s at speed 1 in a container; scraping the container sides and the mixing blade with a scraper while allowing the mixture to rest for 1 minute; mixing further for 1 minute at speed 1; scraping the sides of the container and the mixing blades again while letting the mixture sit for 5 minutes; and then mixing again for 15 s at speed 1.

Tensile Adhesion was determined in accordance with EN 1348 after mixing in accordance with EN 12004:2 (2017) at 25° C. The tensile tester was a direct pull tensile tester capable of applying a load to a pull-head plate at the rate of 250±50 N/s through a suitable fitting that does not exert any bending force, equipped with a connecter for the pull-head plate. Freshly mixed cement-based tile adhesive was applied as a thin layer on a concrete slab using a straight edge trowel, followed by applying a second layer of the tile adhesive and combing in a straight line in a direction parallel to the side of the substrate using a notched trowel having 6 mm×6 mm notches at 12 mm intervals, and holding the trowel at an angle of approximately 60° to the substrate. 9 tiles were then placed on the tile adhesive layer 5 min after the cement-based tile adhesive was applied and a load of 20 N was placed on each tile for 30 s to form a tiled substrate and insure that that tiles set in the wet cement-based tile adhesive. After storage under the indicated conditions, metal pull-head plates were pasted to the top face of each tile with epoxy-containing adhesive. Then, after 24 h further storage after pasting the pull-head plate to the top face of the tile, the adhesion strength was determined with a Herion HP 850 measurement device (Herion, DE), by applying an increasing force with a constant rate of 250±50 N/s. The final adhesion strength value was taken as the average of 9 forces obtained and reported in N/mm². To test tensile adhesion strength under standard conditions (28 day), the tiled substrate was stored for 27 d under standard conditions, and then the pull-head plates were bonded to the tiles. After a further 24 h storage under standard conditions, the tensile adhesion strength of the adhesive was determined by applying a force at a constant rate of 250±50 N/s. To test tensile adhesion strength after water immersion, the tiled substrates were conditioned under standard conditions for 7 d and immersed in water under standard conditions for 20 d. After 20 d, the tiled substrates were removed from the water, wiped with a cloth, and the pull-head plates were bonded to the tiles. After a further 7 h storage under standard conditions, the tiled substrates were immersed in water under standard conditions for 17 more hours. At the end of the 17 hours, the tiled substrates were removed from the water and immediately tested for tensile adhesion strength of the adhesive by applying a force at a constant rate of 250±50 N/s. To test tensile adhesion strength after 70° C. heat aging, the tiled substrates were conditioned under standard conditions for 14 d and then placed in the air-circulating oven at 70±3° C. for a further 14 d. Then, the tiled substrates were removed from the oven and the pull-head plates bonded to the tiles. The tiled substrates were then conditioned for a further 24 h under standard conditions and then tensile adhesion strength was determined by applying a force at a constant rate of 250±50 N/s.

Open Time or “Open Time Adhesion” as determined in accordance with EN 1346 measures the usefulness or ability of a cement-based tile adhesive to function after it has been applied to a cement substrate and left for an indicated time on the substrate. The open time test is a modified tensile adhesion test wherein each tile is placed on a tile adhesive layer after waiting the indicated time period and then exposing the resulting tiled substrate to indicated storage conditions. The rest of the test is the same as the tensile adhesion test and includes each of the (i) standard 28 day; (ii) water immersion and (iii) 70° C. heat aging conditions used in tensile adhesion testing. The final adhesion strength value was taken as the average of 9 forces obtained and reported each from a different tile in N/mm².

Slip Resistance was determined in accordance with EN 1308 after mixing to form the cement-based tile adhesive with a wooden spoon by applying the tile adhesive on a concrete plate using a straight edge trowel, followed by applying a second layer of the tile adhesive and combing in a straight line in a direction parallel to the side of the substrate using a notched trowel having 6 mm×6 mm notches at 12 mm intervals and holding the trowel at an angle of approximately 60° to the substrate. After 2 min, 2 tiles (100×100 mm) were loaded onto the wet tile adhesive applied to the concrete plate and were set with 50N loads for 30 s to form a concrete tile plate. After 3 min, the concrete tile plate was lifted to the vertical position and the distance traveled by tiles on the fresh mortar was recorded when the tile stabilized completely on the wet mortar (no further slip observed).

A Slip test for heavy tiles (KU-27) was carried out by mixing in accordance with EN 1348. The freshly mixed wet tile adhesive was applied on a concrete plate having water up-take according to EN 1323 of from 0.5-1.5 cm³ first as a thin layer using a straight edge trowel, followed by applying a second layer of the tile adhesive and combing in a straight line in a direction parallel to the side of the substrate using a notched trowel having 6 mm×6 mm notches at 12 mm intervals and holding the trowel at an angle of approximately 60° to the substrate. Immediately afterwards, one tile (150×150 mm, mass 750 g+/−15 g) was loaded on the wet mortar applied to the concrete plate and was set with 10N loads for 30 s to form a concrete tile plate. The concrete tile plate was lifted to a vertical position and the distance traveled by tiles on the fresh mortar was recorded after 5 min.

Mortar Density was determined by filling each indicated tile adhesive into a cylinder of a given volume and weighing the tile adhesive in the cylinder to determine the mass of the tile adhesive contents, and dividing its mass by its volume. Densities were reported directly after the fresh mortar was filled into the beaker.

W/S refers to a water (ml) to solids (g) ratio and is treated as unitless.

TABLE 1
Cement-Based Tile Adhesive Formulation

| | Composition |
|---|---|
| Raw Materials | (wt. %) |
| Cement | 35.00 |
| Medium sand | 31.05 |
| Fine sand | 31.05 |
| RDP 1 | 2.5 |
| Cellulose Ether for all tested CE | 0.4 |
| Total | 100 |

The following cellulose ethers were evaluated and their viscosity and COV given in Table 2, below.

TABLE 2
Cellulose Ethers in CBTA Formulations

| | | | | Cross- |
|---|---|---|---|---|
| | | | Viscosity | over |
| | | Cross- | (2% aq., | angular |
| | | linker | RT, | frequency |
| | Cellulose | (mol/mol | Haake, | (COV in |
| Example | Ether | AGU) | mPa · S) | rad/s) |
| 1* and 1A* | 1 | w/o | 29140 | 21.6 |
| 2, 2A and | Crosslinked | 0.0030 | 25730 | 7.6 |
| 2B | cellulose | | | |
| | ether 1 | | | |
| 3 and 3A | Crosslinked | 0.0045 | 29490 | 4.7 |
| | cellulose | | | |
| | ether 2 | | | |

*Denotes Comparative Example

Dry mixes were formed by carefully weighing the indicated ingredients in Table 1 and the indicated cellulose ethers in Table 2, above, as individual raw materials on an electronic balance, dry blending them as powders and letting them rest for 24 hours. The dry mix materials were then testing as indicated, below, after mixing to give the indicated water to solids ratios.

The characteristics of the various cellulose ether materials tested in the Examples are shown in Table 3, below. The characteristics of the various cement-based tile adhesives tested in the Examples are shown in Tables 3, 4 and 5, below. Table 4, below, references a modification package that is also used in Table 5, below. The amount of the modifier package comprises 0.104 wt. %, based on the total solids weight of the dry mix composition.

TABLE 3
Results of Wet Adhesive Tests

| | | | | | | EN 1308 |
|---|---|---|---|---|---|---|
| | | | Shear | Mortar | Mortar | Slip |
| | Cross- | | stability | viscosity | density | resistance |
| Example | linker | W/S | (%) | (Pas) | (g/ml) | (mm) |
| 1* | no | 0.22 | 97.5 | 623 | 1.44 | 3.65 |
| 2 | yes | 0.21 | 97.5 | 594 | 1.46 | 1.20 |
| 3 | yes | 0.21 | 97.5 | 630 | 1.46 | 1.30 |

*Denotes Comparative Example; CE = cellulose ether.

As shown in Table 3, above, the inventive cement-based tile adhesives exhibited a dramatic improvement in slip resistance without use of a slip aid.

TABLE 4
Test Results: Slip Resistance And Open Time

| | | | | | | KU-27 |
|---|---|---|---|---|---|---|
| | | | Shear | Mortar | | Slip |
| | | | sta- | vis- | Mortar | resis- |
| Ex- | Modifier | | bility | cosity | density | tance |
| ample | Package | W/S | (%) | (Pas) | (g/ml) | (mm) |
| 1A* | 10:3 w/w | 0.28 | 95-97.5 | 740 | 1.51 | 1.42 |
| 2A | Starch Ether | 0.28 | 97.5 | 724 | 1.52 | 1.16 |
| 3A | 1:Polyacrylamide | 0.29 | 95-97.5 | 671 | 1.48 | 1.63 |
| 2B | 10:3 w/w | 0.28 | 97.5 | 651 | 1.56 | 0.99 |
| | Starch Ether | | | | | |
| | 1:Polyacrylamide | | | | | |

*Denotes Comparative Example.

TABLE 5
Test Results In Tensile Adhesion And Open Time

| | EN 1346 | EN 1346 | EN 1348 | | |
|---|---|---|---|---|---|
| | Open | Open | 28 day | EN 1348 | EN 1348 |
| | time −20 | time −30 | standard | water | heat aged |
| | min | min | conditions | immersion | (70 C.) |
| EXAMPLE¹ | (N/mm²) | (N/mm²) | (N/mm²) | (N/mm²) | (N/mm²) |
| 1A* | 1.30 | 0.98 | 1.00 | 0.89 | 1.30 |
| 2A | 1.55 | 1.07 | 1.02 | 0.95 | 1.28 |
| 3A | 1.61 | 1.26 | 1.06 | 0.92 | 1.36 |
| 2B | 1.65 | 1.36 | 1.10 | 1.02 | 1.37 |

*Denotes Comparative Example;
¹All cement-based tile adhesives comprised the same formulation as was used in Table 4.

As shown in Table 4, above, the cement-based tile adhesives of inventive Examples 2A, 2B and 3A all exhibited an acceptable slip resistance for heavy tiles, with inventive Examples 2A and 2B exhibiting improved slip resistance. As shown in Table 5, above, the cement-based tile adhesives of inventive Examples 2A, 2B and 3A all exhibited a dramatically improved 30-minute open time even despite their having contained a slip aid modifier package which detrimentally impacts open time.

We claim:

1. A dry mix composition for use in making cement-based tile adhesives comprising:
from 20 to 40 wt. %, of a cement;
from 59.25 to 79.88 wt. %, of sand or an inorganic filler having a sieve particle size of from 80 μm to 0.8 mm; and,
from 0.12 to 0.75 wt. % of one or more gel-like crosslinked cellulose ethers containing polyether groups, all weight proportions based on total weight solids in the dry mix composition and all weight proportions in the dry mix compositions adding up to 100%.

2. The dry mix composition as claimed in claim 1 comprising from 30 to 38 wt. % of a cement.

3. The dry mix composition as claimed in claim 1, wherein a 1.0 wt. % aqueous solution or dispersion of at least one of the one or more gel-like crosslinked cellulose ether containing polyether groups has a crossover point (COV) at which storage modulus (G′) and loss modulus (G″) intersect and are identical when measured by oscillation rheometry of from greater than 1.5 to 8 radians per second (ω or rad/s),
wherein the aqueous solution or dispersion is lump and gel free and is formed by dispersing 1.0 wt. % of the cellulose ether, on a dry basis, under high shear in 99.0 wt. % of water using a high speed laboratory stirrer at 2500 rpm by slowly adding dry cellulose ether to water in a glass container with continuous stirring over a period of 10 sec and continuing stirring at 2500 rpm for an additional 10 sec, followed by sealing the container and rotating the container slowly about its longitudinal (horizontal) axis for a period of 1.5 h, and,
further wherein, the G′ and G″ are measured in Pascal at 20° C. using an oscillating rheometer (Anton Paar MCR 302, Anton Paar, Graz, AT) rheometer equipped with a plate having a 50 mm diameter and a cone having a 1° cone angle and a 0.05 mm flattening of the cone point, and varying the angular frequency (ω) in a range of from 0.1 to 100 ω with a deformation of 0.5%.

4. The dry mix composition as claimed in claim 1, wherein the polyether group in at least one of the one or more gel-like crosslinked cellulose ethers is a polyoxyalkylene which has from 2 to 15 oxyalkylene groups.

5. The dry mix composition as claimed in claim 1, wherein at least one of the one or more gel-like crosslinked cellulose ethers is a mixed cellulose ether that contains hydroxyalkyl groups and alkyl ether groups and has a degree of hydroxyalkyl substitution MS (HE) of from 0.05 to 0.8, and, further, has a degree of alkyl substitution DS (M) of from 1.2 to 2.1.

6. The dry mix composition as claimed in claim 5, wherein at least one of the one or more gel-like crosslinked cellulose ether is a hydroxyethyl methyl cellulose containing polyoxypropylene dioxyethylene ether crosslinks.

7. The dry mix composition as claimed in claim 1, wherein at least one of the one or more gel-like crosslinked cellulose ethers is the crosslinked reaction product of a crosslinked cellulose ether which, absent crosslinking, would have a viscosity of from 5,000 to 36,000 mPa·s, measured as a 2 wt. % solution in water using a rotational rheometer (Haake VISCOTESTER VT550 by Thermo Fisher Scientific, USA) at 20° C. and a shear rate 2.55 s⁻¹.

8. The dry mix composition as claimed in claim 1, comprising at least one gel-like crosslinked cellulose ether containing polyether groups,
wherein a test cement-based tile adhesive comprising the gel-like crosslinked cellulose ether would exhibit each of a 30 minute open time of at least 1.0 N/mm² after each of (i) 28 day aging at 23° C.±2° C. and standard (101.3 kPa) pressure, (ii) 7 days plus 7 hours aging at 23° C.±2° C. and standard (101.3 kPa) pressure and 20 days plus 17 hours water immersion at 23° C.±2° C. and standard (101.3 kPa) pressure, and (iii) 14 day aging at 23° C.±2° C. and standard (101.3 kPa) pressure and then 70° C. heat aging for 14 days when tested at a 0.4 wt. % solids loading of the gel-like crosslinked cellulose ether containing polyether groups in the test cement-based tile adhesive formed by mixing a test dry mix composition comprising the gel-like crosslinked cellulose ether containing polyether groups at 0.4 wt. %, as solids, and, further comprising 35 wt. %, as solids, of ordinary Portland cement, 0.05 wt. % loading, as solids, of a slip resistance aid, and the remainder of sand, a filler or a mixture thereof, all weight proportions based on the total weight of the test dry mix composition solids and adding up to 100%, with water in accordance with EN 12004:2 (2017) to provide a test cement-based tile adhesive having a viscosity at 25° C. of 450 to 700 Pa·s, as measured using a Brookfield rheometer RVDV II Pro (DV II+) equipped with a Helipath stand and spindle No. T96 at 5 rpm.

9. The dry mix composition as claimed in claim 1, comprising at least one gel-like crosslinked cellulose ether containing polyether groups,
wherein a test cement-based tile adhesive comprising the gel-like crosslinked cellulose ether would exhibit a slip resistance of 1.7 mm or less as determined in accordance with EN 1308 on a cement substrate when tested at a 0.4 wt. % solids loading of the gel-like crosslinked cellulose ether containing polyether groups in a test cement-based tile adhesive formed by mixing a test dry mix composition comprising the gel-like crosslinked cellulose ether containing polyether groups at 0.4 wt. %, as solids, and, further comprising, 35 wt. %, as solids, of ordinary Portland cement, no slip aid and the remainder of sand, a filler or a mixture thereof, with water in accordance with EN 12004:2 (2017) to provide a cement-based tile adhesive having a viscosity at 25° C. of 450 to 700 Pa·s, as measured using a Brookfield rheometer RVDV II Pro (DV II+) equipped with a Helipath stand and spindle No. T96 at 5 rpm.

10. A method of using the dry mix compositions as claimed in claim 1, comprising:
mixing the dry composition mix with water to form a cement-based tile adhesive;
applying the tile adhesive to a substrate to form an adhesive bearing substrate; and,
applying a tile to the adhesive bearing substrate.

11. The method as claimed in claim 10, wherein the tile is a heavy tile having a top or bottom surface area of at least 200 cm².
